(19) United States
(12) Patent Application Publication
(10) Pub. No.: US 2014/0076195 A1
(43) Pub. Date: Mar. 20, 2014

(54) Silk Protein Composite Coating Solution and its Preparation Method and Application

(71) Applicant: Yaoqi Jin, Huzhou City (CN)

(72) Inventor: Yaoqi Jin, Huzhou City (CN)

(21) Appl. No.: 13/621,792

(22) Filed: Sep. 17, 2012

(51) Int. Cl. C09D 189/00

(52) U.S. Cl. CPC C09D 189/00
USPC 106/135.1; 106/156.2; 106/153.1

(57) ABSTRACT

Silk protein composite coating solution and its preparation method and application. In weight percent, silk protein complex coating liquid is constituted by the following substances: 2 to 10% of the crosslinking agent, 0.5 to 2% acetic acid, 10 to 20% of the silk protein, the remainder being water. The method for preparation of silk protein composite coating solution has these steps: (1) preparation of the silk protein; (2) silk protein composite coating solution was prepared. Silk protein of the present invention has a natural emollient, antibacterial, and anti-allergic effects, and can be used on daily sanitary supplies for women, infants, and elderlies.

### TECHNICAL FIELD

The present invention relates to silk protein composite coating solution and its preparation method and application.

BACKGROUND ART

Silk protein contains 18 kinds of amino acids and among them glycine, alanine, serine, accounting for more than 70% of the composition, and they are also prominent functional nutrients and are widely used in medicine, food, cosmetics, leather and fabric. The daily use sanitary supplies (sanitary napkins, panty liners, diapers, cotton pad, etc.) market potential is huge. Silk protein is rich in serine and threonine and are natural nutrients affinity with human skin; in addition, silk protein contains extremely rich amino acids, and other natural moisturizing factors (NMF) and with such qualities as moisture absorbing and retention, and moisturizing ability making it excellent skin care product; and at the same time, the studies have found that silk protein can prevent weather related itching and eczema on human, and has antibacterial properties.

With these characteristics and qualities, silk protein can be applied to many daily health and sanitary supplies available in the market. By applying silk protein to the production of health and daily sanitary supplies the finishing product will have the characteristics of skin-friendly and comfortable, protecting the skin, permeability, moisture absorption, anti-bacterial and anti-inflammatory, as well as to prevent skin diseases. While with these advantages, at present time there still isn't a product this sort available in the market.

### SUMMARY OF THE INVENTION

The present invention aims to overcome the deficiencies in related technology and to provide a silk protein composite coating solution.

The second objective of the present invention is to provide a method for the preparation of silk protein composite coating solution.

Yet, another objective of the present invention is to provide applications for silk protein composite coating solution for daily sanitary supplies for women, infants, and young children.

### BRIEF DESCRIPTION OF THE DRAWINGS

None

### DETAILED DESCRIPTION OF THE PREFERRED EMBODIMENTS

The present invention will be further described below in conjunction with specific embodiments:

### Example 1

silk protein composite coating solution preparation steps are as follows:
1. Silk protein preparation:
(a) weighing 100 kg of silk, soak the silk with tap water for 12 hours and then wash the silk with clean water for 5 times, then centrifugate and let it dry;
(b) prepare a bath of by a silk to water weight ratio of 1:6 and put silk and water into the degumming kettle, with steam pressure set at 0.15 mpa degumming 0.5 hours, remove the silk fibroin and wash with clean water, then dehydrate with a centrifuge to obtain 74 kg of silk fibroin;
(c) with a weight ratio of 1:10, soak silk fibroin in 6% concentration of NaOH aqueous solution by weight for 22 hours;
(d) add a 10% concentration of sulfuric acid solution to the NaOH solution until it reaches a PH measure of 6.2 then dehydrate the mix with a centrifuge;
(e) put the mix in a drying room with a drying temperature of 70° C. and dry until the moisture content is 9% then remove the drying content;
(f) with a precision grinder pulverize the drying content 4 times then remove the pulverized powder; dissolve the 44 kg of pulverized powder in 400 kg of clean water and filter the mixture with a nanofiltration membrane to obtain silk protein particle then dehydrate the silk protein particle with a centrifuge, then put into a drying room with a drying temperature controlled at 70° C. dry until the moisture content in the silk protein particle is 5.4%, then take out the silk protein particle to cool to obtain 42 kg of silk protein;
2. Silk protein composite coating solution preparation: heat water to 90° C., and add 2% pupa chitin crosslinking agent, and 0.5% acetic acid, and then stir for 3 hours; add and stir 10% of silk protein to the water and obtain the silk protein composite coating solution.

The above-described technical solution, wherein the method for preparation of the pupa chitin is as follows:

measure 50 kg of pupa shell:
(a) demineralization: with a preparation of 1:20 by weight ratio of pupa shell and 5% concentration of hydrochloric acid; first put 1000 kg of 5% concentration of hydrochloric acid into an acid-resistant vat, and then put the 50 kg of pupa shell into the vat and start agitation process until the contents are uniformly mixed; soak the contents for 20 hours then remove the contents, filter out the hydrochloric acid with a plastic strainer and wash the pupa shell with tap water to remove remaining hydrochloric acid; centrifugate the pupa shell then put pupa shell in a drying room with a drying temperature of 70° C. for 10 hours to obtain 37kg of decalcified pupa shell;
(b) refining cook: with a 1:20 weight ratio of decalcified pupa shell and 10% concentration of sodium hydroxide solution, put the mix in a enamel reactor, heated to boiling temperature then stir, boil for 2 hours then stop heating and let the mix cool, discharge the mix into a filter to filter out the pupa shell; wash the pupa shell with tap water until no more color is washed out from the pupa shell; then centrifugate the pupa shell then put the pupa shell in a drying room with a drying temperature controlled at 75° C. for 8.5 hours; remove the pupa shell measured the moisture content 8.1% and obtain 29.6 kg of crude chitin;
(c) crude chitin purification: by a weight ratio of 1:20 of crude chitin and 1% concentration of aqueous solution of potassium permanganate prepare the mix to start the decolorization of crude chitin; stir the mix at room temperature for 0.5 hour then pour the mix into a cloth bag to filter out potassium permanganate solution and the crude chitin with clean water until no more color is washed out from the crude chitin, then put the crude chitin in a centrifuge, measured the moisture content at 55%;
(d) preparation of chitosan: with a weight ratio of 1:20 of crude chitin and 35% concentration of aqueous NaOH solution, put the mix in an enamel reactor, stir and heat the content until boiling, control the temperature in between 110° C.-120° C. and boil for 5 hours; stop heating use a acid-resistant filter to filter out the aqueous NaOH solution, and then wash the chitin with clean water until no more phenolphthalein response; centrifugate the chitin, measure chitin weight at 45 kg (with moisture); soak the chitin in 10 times volume of 95% concentration ethanol for 9 hours, then filter out the ethanol, centrifugate the chitin and put into a drying room with a temperature controlled at 75° C.; let the chitin dry until the moisture content is 6.9% then remove the chitin and let it cool to obtain 20.1 kg of chitosan.

### Example 2

silk protein composite coating solution preparation steps are as follows:
1. Silk protein preparation:
(a) weighing 100 kg of silk, soak the silk with tap water for 12 hours and then wash the silk with clean water for 5 times, then centrifugate and let it dry;
(b) prepare a bath of by a silk to water weight ratio of 1:8 and put silk and water into the degumming kettle, with steam pressure set at 0.2 mpa degumming 1.5 hours, remove the silk fibroin and wash with clean water, then dehydrate with a centrifuge to obtain 71 kg of silk fibroin;
(c) with a weight ratio of 1:12, soak silk fibroin in 4% concentration of NaOH aqueous solution by weight for 24 hours;
(d) add a 10% concentration of sulfuric acid solution to the NaOH solution until it reaches a PH measure of 6 then dehydrate the mix with a centrifuge;
(e) put the mix in a drying room with a drying temperature of 80° C. and dry until the moisture content is 8.2% then remove the drying content;
(f) with a precision grinder pulverize the drying content 4 times then remove the pulverized powder; dissolve the 40.2 kg of pulverized powder in 395 kg of clean water and filter the mixture with a nanofiltration membrane to obtain silk protein particle then dehydrate the silk protein particle with a centrifuge, then put into a drying room with a drying temperature controlled at 70° C. dry until the moisture content in the silk protein particle is 6.2%, then take out the silk protein particle to cool to obtain 40.5 kg of silk protein;
2. Silk protein composite coating solution preparation: heat water to 75° C., and add 6% pupa chitin crosslinking agent, and 1.3% acetic acid, and then stir for 2 hours; add and stir 15% of silk protein to the water and obtain the silk protein composite coating solution.

The above-described technical solution, wherein the method for preparation of the pupa chitin is as follows: measure 50 kg of pupa shell:

(a) demineralization: with a preparation of 1:20 by weight ratio of pupa shell and 5% concentration of hydrochloric acid; first put 1000 kg of 3% concentration of hydrochloric acid into an acid-resistant vat, and then put the 50 kg of pupa shell into the vat and start agitation process until the contents are uniformly mixed; soak the contents for 24 hours then remove the contents, filter out the hydrochloric acid with a plastic strainer and wash the pupa shell with tap water to remove remaining hydrochloric acid; centrifugate the pupa shell then put pupa shell in a drying room with a drying temperature of 75° C. for 9 hours to obtain 39 kg of decalcified pupa shell;
(b) refining cook: with a 1:20 weight ratio of decalcified pupa shell and 5% concentration of sodium hydroxide solution, put the mix in a enamel reactor, heated to boiling temperature then stir, boil for 4 hours then stop heating and let the mix cool, discharge the mix into a filter to filter out the pupa shell; wash the pupa shell with tap water until no more color is washed out from the pupa shell; then centrifugate the pupa shell then put the pupa shell in a drying room with a drying temperature controlled at 70° C. for 9 hours; remove the pupa shell measured the moisture content 8.3% and obtain 27.4 kg of crude chitin;
(c) crude chitin purification: by a weight ratio of 1:20 of crude chitin and 1% concentration of aqueous solution of potassium permanganate prepare the mix to start the decolorization of crude chitin; stir the mix at room temperature for 1 hour then pour the mix into a cloth bag to filter out potassium permanganate solution and the crude chitin with clean water until no more color is washed out from the crude chitin, then put the crude chitin in a centrifuge, measured the moisture content at 53%;
(d) preparation of chitosan: with a weight ratio of 1:20 of crude chitin and 35% concentration of aqueous NaOH solution, put the mix in an enamel reactor, stir and heat the content until boiling, control the temperature in between 110° C.-120° C. and boil for 6 hours; stop heating use a acid-resistant filter to filter out the aqueous NaOH solution, and then wash the chitin with clean water until no more phenolphthalein response; centrifugate the chitin, measure chitin weight at 43.7 kg (with moisture); soak the chitin in 10 times volume of 95% concentration ethanol for 10 hours, then filter out the ethanol, centrifugate the chitin and put into a drying room with a temperature controlled at 70° C.; let the chitin dry until the moisture content is 7.1% then remove the chitin and let it cool to obtain 18.5 kg of chitosan.

### Example 3

silk protein composite coating solution preparation steps are as follows:
1. Silk protein preparation:
(a) weighing 100 kg of silk, soak the silk with tap water for 12 hours and then wash the silk with clean water for 5 times, then centrifugate and let it dry;
(b) prepare a bath of by a silk to water weight ratio of 1:8 and put silk and water into the degumming kettle, with steam pressure set at 0.1 mpa degumming 2 hours, remove the silk fibroin and wash with clean water, then dehydrate with a centrifuge to obtain 73 kg of silk fibroin;
(c) with a weight ratio of 1:10, soak silk fibroin in 4% concentration of NaOH aqueous solution by weight for 30 hours;
(d) add a 10% concentration of sulfuric acid solution to the NaOH solution until it reaches a PH measure of 6 then dehydrate the mix with a centrifuge;
(e) put the mix in a drying room with a drying temperature of 70° C. and dry until the moisture content is 8.1% then remove the drying content;
(f) with a precision grinder pulverize the drying content 4 times then remove 41.3 pulverized powder; dissolve the 41.3 kg of pulverized powder in 400 kg of clean water and filter the mixture with a nanofiltration membrane to obtain silk protein particle then dehydrate the silk protein particle with a centrifuge, then put into a drying room with a drying temperature controlled at 80° C. dry until the moisture content in the silk protein particle is 6.3%, then take out the silk protein particle to cool to obtain 44 kg of silk protein;
2. Silk protein composite coating solution preparation: heat water to 90° C., and add 10% pupa chitin crosslinking agent, and 2% acetic acid, and then stir for 3 hours; add and stir 20% of silk protein to the water and obtain the silk protein composite coating solution.

The above-described technical solution, wherein the method for preparation of the pupa chitin is as follows:

measure 50 kg of pupa shell:
(a) demineralization: with a preparation of 1: 20 by weight ratio of pupa shell and 3% concentration of hydrochloric acid; first put 1000 kg of 3% concentration of hydrochloric acid into an acid-resistant vat, and then put the 50 kg of pupa shell into the vat and start agitation process until the contents are uniformly mixed; soak the contents for 24 hours then remove the contents, filter out the hydrochloric acid with a plastic strainer and wash the pupa shell with tap water to remove remaining hydrochloric acid; centrifugate the pupa shell then put pupa shell in a drying room with a drying temperature of 75° C. for 9 hours to obtain 40.8 kg of decalcified pupa shell;
(b) refining cook: with a 1:20 weight ratio of decalcified pupa shell and 4% concentration of sodium hydroxide solution, put the mix in a enamel reactor, heated to boiling temperature then stir, boil for 4 hours then stop heating and let the mix cool, discharge the mix into a filter to filter out the pupa shell; wash the pupa shell with tap water until no more color is washed out from the pupa shell; then centrifugate the pupa shell then put the pupa shell in a drying room with a drying temperature controlled at 70° C. for 9 hours; remove the pupa shell measured the moisture content 8.2% and obtain 29.2 kg of crude chitin;
(c) crude chitin purification: by a weight ratio of 1:20 of crude chitin and 0.5% concentration of aqueous solution of potassium permanganate prepare the mix to start the decolorization of crude chitin; stir the mix at room temperature for 0.5 hour then pour the mix into a cloth bag to filter out potassium permanganate solution and the crude chitin with clean water until no more color is washed out from the crude chitin, then centrifugate the crude chitin; then start a second decolorization process with same condition and finally obtain crude chitin of moisture content of 57%;
(d) preparation of chitosan: with a weight ratio of 1:20 of crude chitin and 40% concentration of aqueous NaOH solution, put the mix in an enamel reactor, stir and heat the content until boiling, control the temperature in between 110° C.-120° C. and boil for 4 hours; stop heating use a acid-resistant filter to filter out the aqueous NaOH solution, and then wash the chitin with clean water until no more phenolphthalein response; centrifugate the chitin, measure chitin weight at 44 kg (with moisture); soak the chitin in 10 times volume of 95% concentration ethanol for 9 hours, then filter out the ethanol, centrifugate the chitin and put into a drying room with a temperature controlled at 70° C.; let the chitin dry until the moisture content is 7.3% remove the chitin and let it cool to obtain 17.2 kg of chitosan.

1. Silk protein composite coating solution characterized in that: by weight percentage, the silk protein composite coating solution is constituted by the following substances: crosslinking agent: 2 to 10% acetic acid: 0.5 to 2%; silk protein: 10˜20% of the remainder being water.

2. The silk protein composite coating solution as claimed in claim 1, wherein said silk protein is a water-soluble protein, which including silk peptide, silk essence, and sericin, fibroin, and also including water insoluble silk protein or nano silk protein.

3. The silk protein composite coating solution as claimed in claim 2 wherein, said nano-silk protein has nano-silk protein particles within a range of 1000 nm-1 nm.

4. The silk protein composite coating solution as claimed in claim 1 wherein, said crosslinking agent is of pupa chitin, pupa chitosan or hydrocarbyl silane-based compound with catalyst ZnCL2 composite.

5. The silk protein composite coating solution as claimed in claim 4 wherein, said pupa chitin is prepared with following steps:
(1) demineralization: with a preparation of 1:15˜20 by weight ratio of pupa shell and 3-5% concentration of hydrochloric acid; first put the 3-5% concentration of hydrochloric acid into a acid-resistant vat, and then put the pupa shell into the vat and start agitation process until the contents are uniformly mixed; soak the contents for 20 to 24 hours then remove the contents, filter out the hydrochloric acid with a plastic strainer and wash the pupa shell with tap water to remove remaining hydrochloric acid; centrifugate the pupa shell then put pupa shell in a drying room with a drying temperature of 70-80° C. for 10˜20 hours to obtain decalcified pupa shell;
(2) refining cook: with a 1:20 weight ratio of decalcified pupa shell with a 1:20 weight ratio of pupa shell and 5-10% concentration of sodium hydroxide solution, put the mix in a enamel reactor, heated to boiling temperature then stir, boil for 2-4 hours then stop heating and let the mix cool, discharge the mix into a filter to filter out the pupa shell; wash the pupa shell with tap water until no more color is washed out from the pupa shell; then centrifugate the pupa shell then put the pupa shell in a drying room with a drying temperature controlled between 70-80° C.; let the pupa shell dry until the moisture content is less than 10% to obtain crude chitin;
(3) crude chitin purification: by a weight ratio of 1:20 of crude chitin and 0.5-1% concentration of aqueous solution of potassium permanganate to prepare a mix to start the decolorization of crude chitin; stir the mix at room temperature for 0.5 to 1 hour then pour the mix into a cloth bag to filter out potassium permanganate solution and the crude chitin with clean water until no more color is washed out from the crude chitin, then put the crude chitin in a centrifuge, monitor the moisture content;
(4) preparation of chitosan: with a weight ratio of 1:20 of crude chitin and 35-45% concentration of aqueous NaOH solution, put the mix in an enamel reactor, stir and heat the content until boiling, control the temperature in between 110° C.-120° C. and boil for 4-6 hours; stop heating use a acid-resistant filter to filter out the aqueous NaOH solution, and then wash the chitin with clean water until no more phenolphthalein response; centrifugate the chitin; soak the chitin in 10 times volume of 95% concentration ethanol for 10 hours, then filter out the ethanol, centrifugate the chitin and put into a drying room with a temperature controlled between 70-80° C.; let the chitin dry until the moisture content is 8% or less then remove the chitin and let it cool to obtain chitosan.

6. The silk protein composite coating solution as claimed in claim 1 wherein, the silk protein composite solution is obtained and prepared in the following steps:
(1) obtain silk protein: with tap water, (a) soak silk for 12 hours or more, and then washed 3 to 5 times with pure water, dehydrated with a centrifuge, then measure the moisture;
(b) prepare a bath of by a silk to water weight ratio of 1:6˜10 and put silk and water into the degumming kettle, with steam pressure set between 0.1˜0.2 mpa degumming 0.5 to 2 hours, remove the silk fibroin and wash with clean water, then dehydrate with a centrifuge, then measure the moisture; (b) soak silk fibroin in 4 to 6% concentration of NaOH aqueous solution by weight for 20 to 30 hours; with a silkworm fibroin to aqueous NaOH solution in a weight ratio of 1:10 to 12; (d) after soaking, by weight, add a 10% concentration of sulfuric acid solution to the NaOH solution until it reaches a PH measure of 5 to 7; (e) dehydrate the NaOH solution with a centrifuge then put into a drying room with a drying temperature of 70-80° C. and dry until the moisture content is less than 10% then remove the drying content; (f) with a precision grinder pulverize the drying content 3-5 times then remove the pulverized powder; dissolve the pulverized powder in clean water and filter the solution with a nanofiltration membrane to obtain silk protein particle with size of ≦400 mm; then dehydrate the silk protein particle with a centrifuge, then put into a drying room with a drying temperature controlled around 70-80° C. until the moisture content in the silk protein particle is less than 8%, then take out the silk protein particle to cool to obtain silk protein;
(2) silk protein composite coating solution preparation: heat water to 60-90° C., and add 2-10% crosslinking agent, and 0.5-2% acetic acid, and then stir for 0.5 to 3 hours; add and stir 10-20% of silk protein to the water and obtain the silk protein composite coating solution.

7. The silk protein composite coating solution as claimed in claim wherein, the silk protein composite coating solution is applied to daily sanitary supplies for women, infants, and young children.
